(19) United States
(12) Patent Application Publication
(10) Pub. No.: US 2026/0064262 A1
(43) Pub. Date: Mar. 5, 2026

(54) STRUCTURED DOCUMENT DISPLAY SYSTEM

(71) Applicant: TOYOTA JIDOSHA KABUSHIKI KAISHA, Toyota-shi (JP)

(72) Inventors: Hiroyasu YAMASHITA, Toyota-shi (JP); Kazuya Matsumoto, Nagoya-shi (JP); Harufumi Muto, Miyoshi-shi (JP); Yosuke Ueno, Nagoya-shi (JP)

(73) Assignee: TOYOTA JIDOSHA KABUSHIKI KAISHA, Toyota-shi (JP)

(21) Appl. No.: 19/308,878

(22) Filed: Aug. 25, 2025

(30) Foreign Application Priority Data
Aug. 29, 2024 (JP) 2024-147614

(51) Int. Cl. G06F 3/0485; G06F 3/0481; G06F 3/0487; G06F 3/0354

(52) U.S. Cl. CPC G06F 3/0485; G06F 3/0481; G06F 3/0487; G06F 3/03543

(57) ABSTRACT

A structured document display system is provided with a display displaying an image indicating a correspondence relationship between a first structured document and a second structured document, and a display controller controlling the display. The image includes a first area disposed on one side in the left-right direction and displaying the first structured document and a second area disposed on the other side in the left-right direction and displaying the second structured document. When there is input to scroll in a case where a mouse pointer overlaps one of the first area and the second area, the display controller controls the display to scroll the document displayed in one of the first area and the second area. The display controller controls the display to display a correspondence relationship related to documents displayed on the image for a predetermined period of time or longer.

### CROSS-REFERENCE TO RELATED APPLICATIONS

This application is based upon and claims the benefit of priority of the prior Japanese Patent Application No. 2024-147614, filed on August 29, 2024, the entire contents of which are incorporated herein by reference.

### BACKGROUND

### 1. Technical Field

Embodiments of the present disclosure relate to the technical field of a structured document display system.

### 2. Description of the Related Art

As an example of this type of system, a system has been proposed that associates each block of a first document and a second document, each consisting of blocks, and outputs the results of the associating (refer to JP2023-114230A (Patent Literature 1)).

A person (e.g., an operator of a system) may verify the document associating performed by a system using machine learning models. In this case, the person may correct the document associating if necessary. However, when the person verify document associating, there is a technical issue in that the time required for verification may increase depending on the output of the associating results.

### SUMMARY

In view of the aforementioned problems, it is therefore an object of embodiments of the present disclosure to provide a structured document display system that enable a user to efficiently verify associating.

A structured document display system of one aspect of the present disclosure is a structured document display system for displaying a correspondence relationship between a first structured document containing a plurality of documents in a hierarchical relationship and a second structured document containing a plurality of documents in a hierarchical relationship, comprising: a receiver configured to receive input of a user; a display configured to display an image indicating the correspondence relationship between the first structured document and the second structured document; and a display controller configured to control the display, wherein the image includes a first area disposed on one side of the image in the left-right direction and displaying at least a part of the plurality of documents included in the first structured document, and a second area disposed on the other side of the image in the left-right direction and displaying at least a part of the plurality of documents included in the second structured document, the receiver includes a mouse, when the receiver receives input from the user to scroll the image up or down in a case where a mouse pointer associated with the mouse overlaps one of the first area and the second area, the display controller controls the display to scroll the document displayed in one of the first area and the second area, and the display controller controls the display to display a correspondence relationship related to documents displayed on the image for a predetermined period of time or longer.

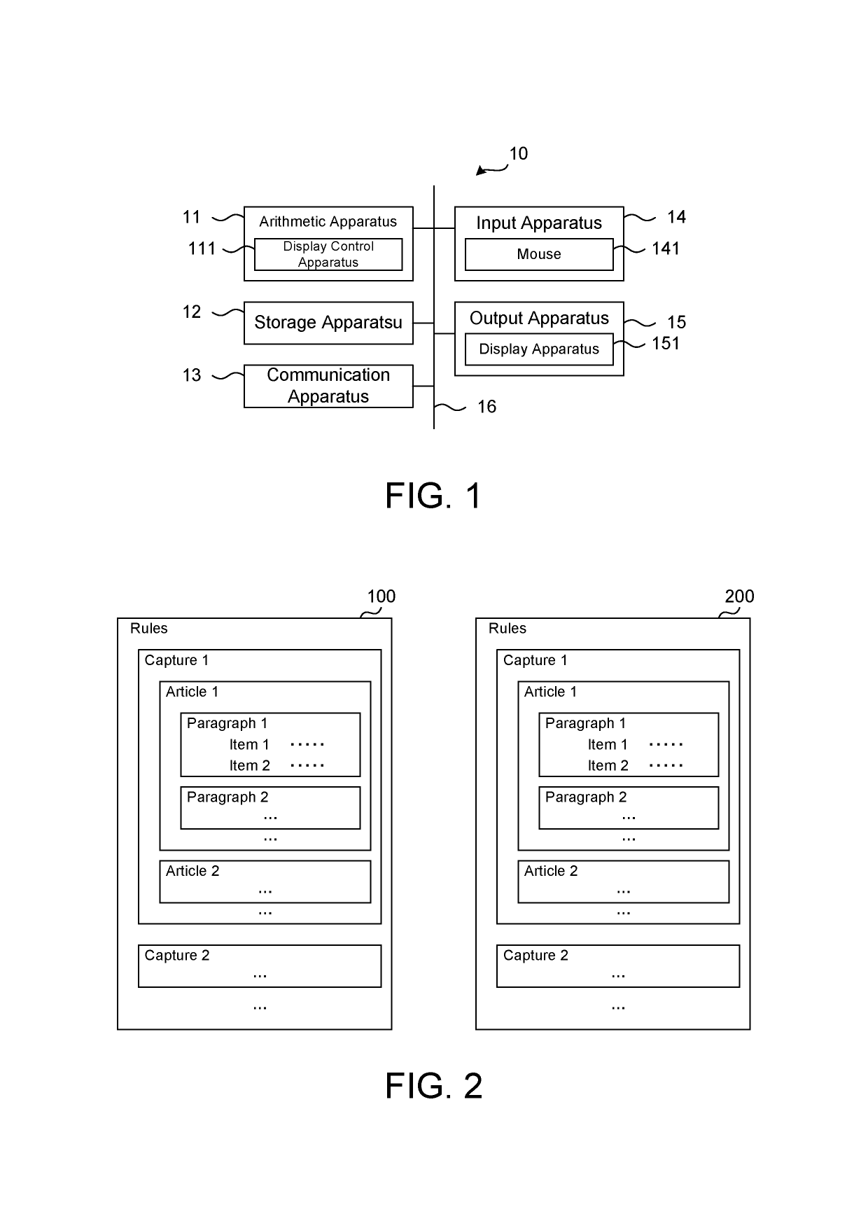

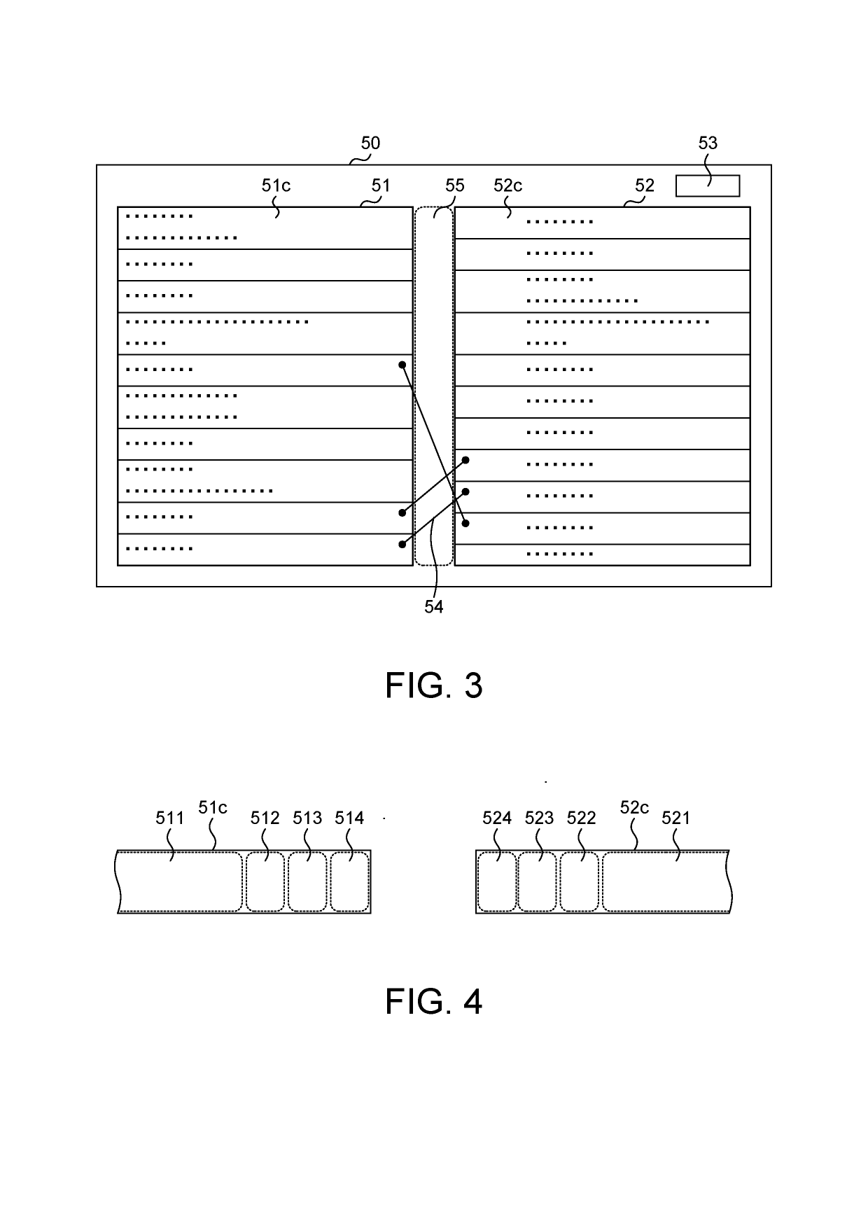

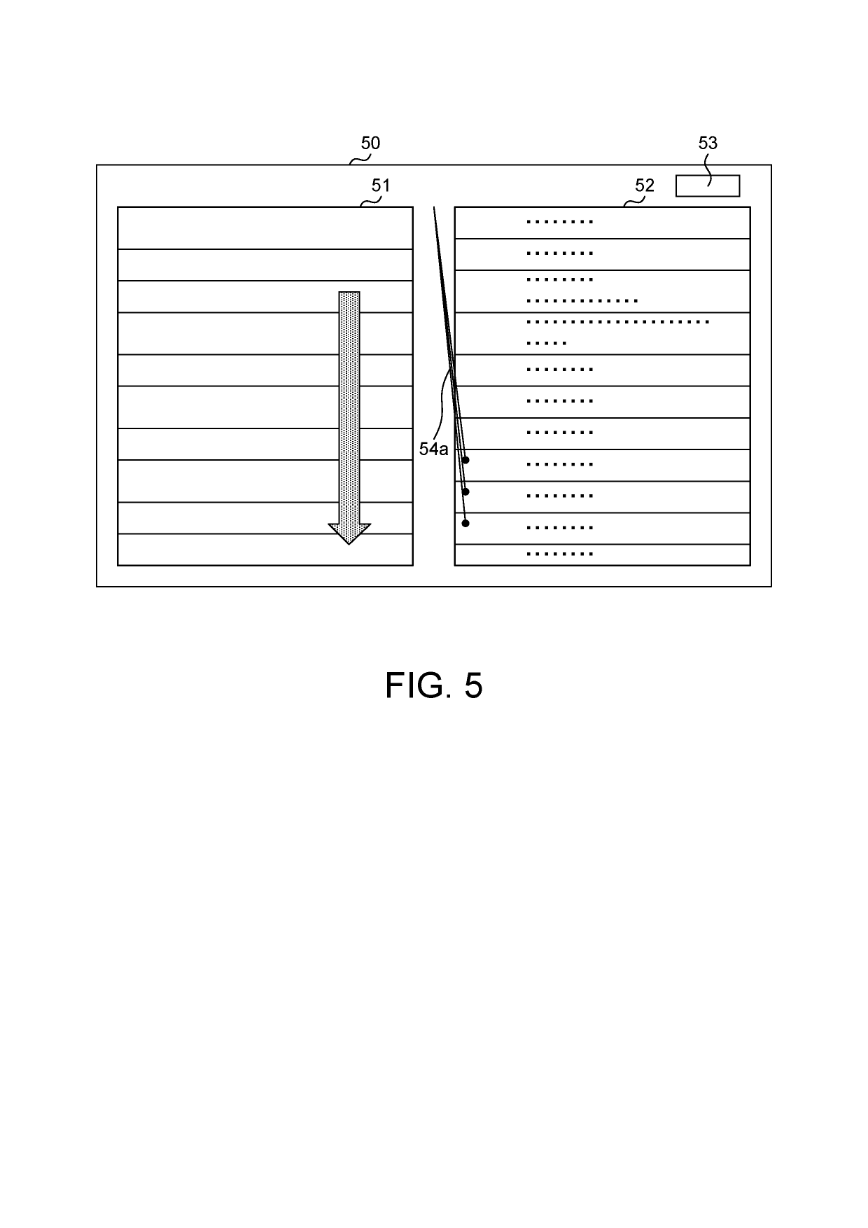

### BRIEF DESCRIPTION OF THE DRAWINGS

[FIG. 1] FIG. 1 is a block diagram showing an example of configuration of a system according to an embodiment.

[FIG. 2] FIG. 2 is a conceptual diagram showing an example of a structured document.

[FIG. 3] FIG. 3 is a diagram showing an example of a display image according to the embodiment.

[FIG. 4] FIG. 4 is an enlarged view showing a part of the display image according to the embodiment.

[FIG. 5] FIG. 5 is a diagram showing another example of a display image according to the embodiment.

### DETAILED DESCRIPTION OF THE EMBODIMENTS

An embodiment of a structured document display system will be described with reference to FIG. 1 to FIG. 5. In the following, an embodiment of a structured document display system will be described using a system 10.

### Configuration of System

In FIG. 1, the system 10 is provided with an arithmetic apparatus 11, a storage apparatus 12, a communication apparatus 13, an input apparatus 14, and an output apparatus 15. The arithmetic apparatus 11, the storage apparatus 12, the communication apparatus 13, the input apparatus 14, and the output apparatus 15 may be connected via a data bus 16. The arithmetic apparatus 11, the storage apparatus 12, the communication apparatus 13, the input apparatus 14, and the output apparatus 15 may be connected via a network instead of the data bus 16. Wherein the system 10 corresponds to an example of a structured document display system.

The arithmetic apparatus 11 may have one or more processors. The processor may be at least one of a CPU (Central Processing Unit) and a GPU (Graphics Processing Unit), for example.

The storage apparatus 12 may have one or more memories. The memory may be at least one of a RAM (Random Access Memory), a ROM (Read Only Memory), a hard disk apparatus, an optical magnetic disk apparatus, an SSD (Solid State Drive), and an optical disk array, for example.

The communication apparatus 13 may be capable of communicating with an apparatus external to the system 10. The communication apparatus 13 may perform wired communication or wireless communication.

The input apparatus 14 is an apparatus capable of accepting input of information to the system 10 from outside. The input apparatus 14 may include an operation apparatus (e.g., a keyboard, a mouse, a touch panel, etc.) operable by a user of the system 10. The input apparatus 14 may include a recording medium reading device capable of reading information recorded on a recording medium that can be attached to and detached from the system 10, such as a USB (Universal Serial Bus) memory. When information is input to the system 10 via the communication apparatus 13 (in other words, when the system 10 acquires information via the communication apparatus 13), the communication apparatus 13 may function as an input apparatus. In this embodiment, the input apparatus 14 includes a mouse 141 with a wheel.

The output apparatus 15 is an apparatus capable of outputting information to the outside of the system 10. The output apparatus 15 may output visual information such as characters and images, auditory information such as voice, or tactile information such as vibration as the above information. The output apparatus 15 may include, for example, at least one of a display, a speaker, a printer, and a vibration motor. The output apparatus 15 may be capable of outputting information to a recording medium that is detachable from the system 10, such as a USB memory. When the system 10 outputs information via the communication apparatus 13, the communication apparatus 13 may function as an output apparatus. In this embodiment, the output apparatus 15 includes a display apparatus 151.

The storage apparatus 12 is capable of storing desired data. The memory of the storage apparatus 12 may store a computer program executed by the arithmetic apparatus 11. The storage apparatus 12 may temporarily store data temporarily used by the arithmetic apparatus 11 when the arithmetic apparatus 11 is executing the computer program. For example, by the arithmetic apparatus 11 executing the computer program, logical function blocks for executing processing to be performed by the system 10 within the arithmetic apparatus 11 may be realized. In the present embodiment, a display control unit 111 may be realized in the arithmetic apparatus 11 by the arithmetic apparatus 11 executing a computer program.

### Structured document

An example of a structured document will be described with reference to FIG. 2. The structured document may mean a plurality of documents in a hierarchical relationship. In this embodiment, structured documents 100 and 200 are given as examples of structured documents. In FIG. 2, the structured documents 100 and 200 are described as rules. However, structured documents are not limited to rules.

In FIG. 2, the structured document 100 includes Chapter 1 and Chapter 2. Chapter 1 includes Article 1 and Article 2. Article 1 includes Paragraph 1 and Paragraph 2. Paragraph 1 includes Item 1 and Item 2. Similarly, the structured document 200 includes Chapter 1 and Chapter 2. Chapter 1 includes Article 1 and Article 2. Article 1 includes Paragraph 1 and Paragraph 2. Here, “Chapter 1” and “Chapter 2” may be the top-level hierarchy. “Article 1” and “Article 2” are sub-hierarchies of the “Chapter 1” hierarchy. “Paragraph 1” and “Paragraph 2” are sub-hierarchies of the “Article 1” hierarchy. “Item 1” and “Item 2” are sub-hierarchies of the “Paragraph 1” hierarchy.

The structured document 100 may be associated with structured document 200. In other words, a correspondence relationship between the structured document 100 and the structured document 200 may be generated. The structured documents 100 and 200 may be stored in the storage apparatus 12 of the system 10. The correspondence relationship between the structured document 100 and the structured document 200 may also be stored in the storage apparatus 12. The correspondence between the structured document 100 and the structured document 200 may be performed by the system 10 or by an apparatus or a system other than the system 10. Incidentally, since various existing methods can be applied to the correspondence between structured documents, a detailed description thereof is omitted.

For example, the structured document 100 and the structured document 200 may each be the rules before and after revision. For example, the structured document 100 and the structured document 200 may each be Japanese rules and foreign rules. For example, the structured document 100 and the structured document 200 may each be the rules of one foreign country and the rules of another foreign country different from the one foreign country.

### System operation

The system 10 may display the correspondence between the structured document 100 and the structured document 200. The display control unit 111 of the system 10 may control the display apparatus 151 to display the image 50 shown in FIG. 3. As a result, the correspondence between the structured document 100 and the structured document 200 may be displayed on the display apparatus 151.

In FIG. 3, the image 50 includes an area 51 in which at least a part of a plurality of documents included in the structured document 100 is displayed, and an area 52 in which at least a part of a plurality of documents included in the structured document 200 is displayed. The image 50 includes a button 53 which can be selected by a user of the system 10 via the input apparatus 14 (e.g., the mouse 141).

The display control unit 111 may control the display device 151 so that at least a part of the plurality of documents included in the structured document 100 is displayed in the area 51. At this time, the display control unit 111 may control the display device 151 so that one document included in the structured document 100 is displayed in one cell (see, for example, a cell 51c in FIG. 3).

Similarly, the display control unit 111 may control the display device 151 so that at least a part of the plurality of documents included in the structured document 200 is displayed in the area 52. In this case, the display control unit 111 may control the display device 151 so that one document included in the structured document 200 is displayed in one cell (see, for example, a cell 52c in FIG. 3).

The display control unit 111 may control the display device 151 to display lines (see, for example, a line 54) indicating the correspondence between a document included in the structured document 100 and a document included in the structured document 200 based on the correspondence between the structured document 100 and the structured document 200.

The cell 51c, in which a document included in the structured document 100 is displayed, and the cell 52c, in which a document included in the structured document 200 is displayed, will be described in more detail with reference to FIG. 4.

In FIG. 4, the cell 51c may include areas 511, 512, 513, and 514. The area 511 displays, for example, a document included in the structured document 100. The area 512 displays hierarchical information related to the document displayed in the area 511. For example, if the document displayed in the area 511 is Chapter 1, Article 1, Paragraph 1, Item 1, the area 512 may display “1.1.1.1.” The area 513 displays area information related to the document displayed in the area 511. The area information may indicate the area to which the document displayed in the area 511 belongs. The “area” may mean a group of documents with the same meaning. Incidentally, the area information may be assigned by the administrator of the structured document.

The area 514 displays information related to the correspondence between documents displayed in the area 511. For example, information related to correspondence may include “none,” “temporary,” and “confirmed.” The “None” may mean that there is no correspondence. The “temporary” may mean that the correspondence is the result of associating with structured documents performed by a system (e.g., the system 10 or another system). The “confirmed” may mean that the result of associating with structured documents performed by a system, etc., has been confirmed by a person and/or determined by a person. By configuring the system in this way, a user can relatively easily recognize the status of the correspondence.

Similarly, the cell 52c may include areas 521, 522, 523, and 524. The area 521 displays, for example, one document included in the structured document 200. The area 522 displays hierarchical information related to the document displayed in the area 521. The area 523 displays area information related to the document displayed in the area 521. The area 524 displays information related to the correspondence between the document displayed in the area 521 and other documents.

Incidentally, the positions of areas 511, 512, 513, and 514 in the cell 51c are examples and are not limited thereto. Similarly, the positions of areas 521, 522, 523, and 524 in the cell 52c are examples and are not limited thereto.

Next, an example of the response of the display control unit 111 to user input of the system 10 will be described.

For example, when the mouse pointer associated with the mouse 141 is superimposed on the area 51 of the image 50, and the mouse 141 receives user input (e.g., operation of the wheel of the mouse 141) to scroll the image 50 up or down, the display control unit 111 may control the display apparatus 151 to scroll the document displayed in the area 51. In this case, the display control unit 111 may control the display device 151 so that the document displayed in the area 52 is not scrolled.

For example, when the mouse pointer is superimposed on the area 52 of the image 50 and the mouse 141 receives input from the user to scroll the image 50 up or down, the display control unit 111 may control the display device 151 to scroll the document displayed in the area 52. In this case, the display control unit 111 may control the display device 151 so that the document displayed in the area 51 is not scrolled.

For example, when the mouse pointer is superimposed on the area 55 of the image 50 (i.e., the area between areas 51 and 52) and the mouse 141 receives input from the user to scroll the image 50 up or down, the display control unit 111 may control the display device 151 to scroll both the document displayed in the area 51 and the document displayed in the area 52. By configuring the system in this way, the document displayed in the area 51 and the document displayed in the area 52 are scrolled simultaneously, thereby improving the user's visibility.

For example, when the mouse pointer is superimposed on the area 51 of the image 50 and the mouse 141 receives input from the user to scroll the image 50 downward, the display control unit 111 may control the display device 151 to scroll the document displayed in the area 51 downward. In this case, as shown in FIG. 5, the display control unit 111 may control the display device 151 to display lines (e.g., lines 54a) indicating the correspondence between the documents displayed in the area 52. On the other hand, the display control unit 111 may control the display device 151 so as not to display lines indicating the correspondence between the documents displayed in the area 51. In other words, the display control unit 111 may control the display device 151 so as to display the correspondence relating to the documents displayed on the image 50 for a predetermined period or longer.

Incidentally, when the mouse pointer is superimposed on the area 51 of the image 50 and the mouse 141 receives input from the user to scroll the image 50 downward, the display control unit 111 may control the display device 151 to temporarily erase the lines indicating the correspondence displayed on the image 50. Thereafter, the display control unit 111 may control the display device 151 to display lines indicating the correspondence between documents displayed in the area 52 that has not been scrolled. If, during scrolling of the area 51, lines indicating the correspondence between documents displayed in the area 51 are displayed on the image 50, the lines indicating the correspondence move with the scrolling of the area 51, making it difficult for the user to grasp the correspondence. Furthermore, the display of the lines indicating the correspondence relationship may cause the image 50 to become cluttered. In other words, during scrolling of the area 51, if the lines indicating the correspondence relationship between the documents displayed in the area 51 are displayed in the image 50, the user's visibility may be impaired.

In response to this, the display control unit 111 may control the display apparatus 151 so as not to display lines indicating the correspondence between documents displayed in the area 51 during scrolling of the area 51. With this configuration, the visibility for the user can be improved.

For example, when the input apparatus 14 receives input (e.g., a click operation of the mouse 141) from the user selecting one document of the documents displayed in the area 51, the display control unit 111 may control the display apparatus 151 so that the one document displayed in the area 51 and a document corresponding to the one document (i.e., a document associated with the one document among documents included in the structured document 200) are displayed at the center in the vertical direction of the image 50.

Here, as shown in FIG. 3, the height of the cells (e.g., cells 51c and 52c) may vary depending on the number of lines of the document being displayed. For example, when the display control unit 111 receives input from a user selecting a document displayed in the area 51, the display control unit 111 may control the display device 151 so that the height of the cell in the area 51 displaying the document selected by the user and the height of the cell in the area 52 displaying the document corresponding to the selected document are close to each other (typically, equal to each other).

With this configuration, the user can relatively easily confirm the document corresponding to the document selected by the user. If there are a plurality of documents corresponding to the selected document, the display control unit 111 may control the display device 151 so that the document with the highest hierarchy among the plurality of corresponding documents is displayed at the center in the vertical direction of the image 50.

For example, when the input apparatus 14 receives user input specifying the hierarchy of documents displayed in at least one of the areas 51 and 52, the display control unit 111 may control the display device 151 to display only documents of the specified hierarchy in at least one of the areas 51 and 52. The display control unit 111 may then control the display device 151 to display lines (e.g., the lines 54) indicating the correspondence between the documents displayed in the areas 51 and 52. In structured documents, the concept of a document often changes with each hierarchy. For example, as the hierarchy level increases, the concepts of the documents tend to become more abstract. In other words, as the hierarchy level decreases, the concepts of the documents tend to become more concrete. For example, by aligning the hierarchy of the documents displayed in the area 51 with the hierarchy of the documents displayed in the area 52, the conceptual level of the documents displayed in the area 51 can be aligned with the conceptual level of the documents displayed in the area 52.

Incidentally, the user may specify the hierarchy of documents displayed in the area 51 and the hierarchy of documents displayed in the area 52 separately. Alternatively, the hierarchy of documents displayed in the area 51 and the hierarchy of documents displayed in the area 52 may be set according to a single input from the user specifying the hierarchy.

For example, when the input apparatus 14 receives input from the user specifying an area of a document displayed in at least one of the areas 51 and 52, the display control unit 111 may control the display device 151 so that only the document in the specified area is displayed in at least one of the areas 51 and 52. In this case, the display control unit 111 may control the display device 151 so that the document in the specified area is displayed at the center in the vertical direction of the image 50. With this configuration, the user can check documents for each area.

For example, when the input apparatus 14 receives input from the user selecting the button 53, the display control unit 111 may control the display device 151 to switch the display of the original text and the translated text displayed in the areas 51 and 52, respectively, while maintaining the positions of the documents displayed in the areas 51 and 52 and the lines (e.g., the lines 54) indicating the correspondence relationship.

For example, the input apparatus 14 may receive input from a user selecting one of the documents displayed in the area 51. Thereafter, the input apparatus 14 may receive input from a user selecting one of the plurality of documents displayed in the area 52. Thereafter, the input apparatus 14 may receive input from a user associating the one document displayed in the area 51 with the plurality of documents displayed in the area 52. As a result, the arithmetic apparatus 11 may associate the document displayed in the area 51 with the plurality of documents displayed in the area 52. In other words, the arithmetic apparatus 11 may associate the plurality of documents displayed in the area 52 with the document displayed in the area 51 in a batch. With this configuration, the work efficiency of the user can be improved.

### Technical effect

As described above, in the system 10, the image 50 displayed on the display apparatus 151 changes in response to the user's input. For example, in the system 10, the document selected by the user is displayed at the center in the vertical direction of the image 50. For example, in the system 10, the document displayed in the area 51 and the document displayed in the area 52 are scrolled independently of each other in response to the user's input. Alternatively, in the system 10, the documents displayed in area 51 and the documents displayed in area 52 scroll simultaneously in response to user input. Therefore, according to the system 10, the user can efficiently confirm the results of the mapping between structured documents performed by a system (e.g., the system 10 or another system).

### Aspects of the invention led from the embodiments described above will be described below.

A structured document display system of one aspect of the invention is a structured document display system for displaying a correspondence relationship between a first structured document containing a plurality of documents in a hierarchical relationship and a second structured document containing a plurality of documents in a hierarchical relationship, comprising: a receiver configured to receive input of a user; a display configured to display an image indicating the correspondence relationship between the first structured document and the second structured document; and a display controller configured to control the display, wherein the image includes a first area disposed on one side of the image in the left-right direction and displaying at least a part of the plurality of documents included in the first structured document, and a second area disposed on the other side of the image in the left-right direction and displaying at least a part of the plurality of documents included in the second structured document, the receiver includes a mouse, when the receiver receives input from the user to scroll the image up or down in a case where a mouse pointer associated with the mouse overlaps one of the first area and the second area, the display controller controls the display to scroll the document displayed in one of the first area and the second area, and the display controller controls the display to display a correspondence relationship related to documents displayed on the image for a predetermined period of time or longer.

In the above-mentioned embodiments, the “input apparatus 14” corresponds to one example of the “receiver”, the “display apparatus 151” corresponds to one example of the “display”, and the “display control unit 111” corresponds to one example of the "display controller”.

In the structured document display system, when the receiver receives input from the user to scroll the image up or down in a case where a mouse pointer associated with the mouse overlaps an area between the first area and the second area, the display controller may control the display to scroll the documents displayed in the first area and the second area, respectively.

In the structured document display system, when the receiver receives input from the user specifying the hierarchy of the document, the display controller may control the display so that the document of the specified hierarchy is displayed in at least one of the first area and the second area.

In the structured document display system, when the receiver receives input from the user selecting a document displayed in one of the first area and the second area, the display controller may control the display so that the selected document and a document corresponding to the selected document are displayed at the center in the vertical direction of the image.

The present discloser is not limited to the above-described embodiments. The present discloser may be changed as appropriate within the scope of the invention as described in the claims and the entire description. A structured document display system with such changes is also included in the scope of the present invention.

What is claimed is:

1. A structured document display system for displaying a correspondence relationship between a first structured document containing a plurality of documents in a hierarchical relationship and a second structured document containing a plurality of documents in a hierarchical relationship, comprising:
a receiver configured to receive input of a user;
a display configured to display an image indicating the correspondence relationship between the first structured document and the second structured document; and
a display controller configured to control the display,
wherein
the image includes a first area disposed on one side of the image in the left-right direction and displaying at least a part of the plurality of documents included in the first structured document, and a second area disposed on the other side of the image in the left-right direction and displaying at least a part of the plurality of documents included in the second structured document,
the receiver includes a mouse,
when the receiver receives input from the user to scroll the image up or down in a case where a mouse pointer associated with the mouse overlaps one of the first area and the second area,
the display controller controls the display to scroll the document displayed in one of the first area and the second area, and
the display controller controls the display to display a correspondence relationship related to documents displayed on the image for a predetermined period of time or longer.

2. The structured document display system according to claim 1, wherein
when the receiver receives input from the user to scroll the image up or down in a case where a mouse pointer associated with the mouse overlaps an area between the first area and the second area, the display controller controls the display to scroll the documents displayed in the first area and the second area, respectively.

3. The structured document display system according to claim 1, wherein
when the receiver receives input from the user specifying the hierarchy of the document, the display controller controls the display so that the document of the specified hierarchy is displayed in at least one of the first area and the second area.

4. The structured document display according to claim 1, wherein
when the receiver receives input from the user selecting a document displayed in one of the first area and the second area, the display controller controls the display so that the selected document and a document corresponding to the selected document are displayed at the center in the vertical direction of the image.
